(19) United States
(12) Patent Application Publication
(10) Pub. No.: US 2015/0083347 A1
(43) Pub. Date: Mar. 26, 2015

(54) ARCHITECTURAL SHIELD APPARATUS AND METHODS

(71) Applicant: George V. Garcia, Westminster, CA (US)

(72) Inventor: George V. Garcia, Westminster, CA (US)

(21) Appl. No.: 14/491,942

(22) Filed: Sep. 19, 2014

Related U.S. Application Data
(60) Provisional application No. 61/880,736, filed on Sep. 20, 2013.
(60) Provisional application No. 61/888,973, filed on Oct. 9, 2013.

(51) Int. Cl. E06B 3/30; E04F 13/07

(52) U.S. Cl. CPC E06B 3/30; E04F 13/07
USPC 160/127; 160/368.1; 29/428; 29/525.01

(57) ABSTRACT

An architectural shield apparatus and methods, involving at least one material sheet having an upper portion and a lower portion, the upper portion adapted for rotatable coupling with an edificial feature, and the lower portion adapted for coupling and decoupling with the edificial feature, and at least one deployment device adapted for coupling with the edificial feature and for coupling and decoupling the lower portion of the material sheet in relation to the edificial feature.

### CROSS-REFERENCE TO RELATED APPLICATION(S)

This document is a provisional application and claims priority to, and the benefit of, U.S. Provisional Patent Application Ser. No. 61/880,736, filed on Sep. 20, 2013, also entitled “ARCHITECTURAL SHIELD APPARATUS AND METHODS,” and U.S. Provisional Patent Application Ser. No. 61/888,973, filed on Oct. 9, 2013, also entitled “ARCHITECTURAL SHIELD APPARATUS AND METHODS,” all of which are herein incorporated by reference in their entirety for all purposes.

### TECHNICAL FIELD

The present disclosure technically relates to the field of architectural accessories. More particularly, the present disclosure technically relates to the field of architectural accessories for retrofitting portions of buildings. Even more particularly, the present disclosure technically relates to the field of architectural accessories for retrofitting garages.

### BACKGROUND

Architectural accessories typically involve architectural elements that enhance the visual appearance of an edifice. Some related art architectural accessories are fixed awnings, retractable awnings, fixed patio covers, retractable patio covers, louver patio covers, adjustable louver patio covers, fixed patio enclosures, such as sunrooms, shutters, plantation shutters, roll shutters, skylights, fixed screen doors, retractable screen doors, storm doors, garage doors, and rolling garage doors.

In the related art, U.S. Pat. No. 7,775,251 to Ward discloses a customizable garage door screen, having four elastic straps with hooks at each end, being used with six grommets that are strategically placed on the screen for stability, and approximately one dozen screw and snap fasteners are installed around the perimeter of the screen and garage door frame. To open the garage door screen for egress and ingress, one or both of the lower elastic straps must be manually unhooked, after unsnapping the desired number of end-caps, and then latch them upon the upper elastic straps or guide rails on either side.

U.S. Pat. No. 6,257,307 to Tollivar discloses a magnetic customized garage door screen that includes a screen surrounded by a border. The border includes magnetic strips that interface with metal strips located on a garage door. The magnetic strips can be secured to the border using adhesives and the metal strips can be secured to the door frame using double-sided tape. The door screen includes a zipper or handles along a side thereof to allow entry into or exit from the garage. At least the border and metal strips are color matched to the color of the door frame so that the metal strips are inconspicuous when exposed and the border blends in with the door frame color when installed.

U.S. Pat. No. 5,427,169 to Saulters discloses a garage screen enclosure for attachment to a garage door frame, the enclosure having a passageway which can be opened and closed using a pair of double sided zippers. The screen or portions of the screen can be wrapped around dowel rods and suspended from the garage door frame. Devices secure the zipper so that the passageway can be locked.

U.S. Pat. No. 5,323,835 to Bachmeier discloses a screen that is provided for a garage door that has the same dimensions as the garage door. A Velcro® fastening system is utilized to secure the top and opposite side edges of the flexible screen to the interior door casing such that the screen will be positively maintained in place to prevent the passage of insects, leaves, etc. into the garage. A vertically disposed double zipper is provided in the screen to permit access into the interior of the garage or exit therefrom.

U.S. Pat. No. 6,754,986 to McLaughlin discloses an advertisement delivery system for an overhead garage door entryway, involving a flexible retractable screen assembly for any garage door of the type that ends with the garage door substantially parallel to a garage floor when in a fully opened condition. The assembly includes a frame sub-assembly with bases symmetrically disposed in the corners of an entire interior side of a garage door. Vertically positioned flexible track members, disposed at opposite ends of garage door, are mounted, elevated from the door to traverse an entire height of garage door in respective end corner bases. Flexible dual-purpose conjunctive rods, disposed at opposite ends, slidably engage respective bases and tracks as well as screen sub-assembly attachment slips. Fixedly attached to each rod above and below screen sub-assembly attachment slips to restrict their movement are respectively, a horizontal support brace and a concert drag. A rod end of each respective rod increases in dimension and acts as a wedge to releasably lock each rod in its respective base, during operation of a garage door. A single screen panel sub-assembly consists of attachment slips, vertically positioned disposed at opposite ends on vertical seams between a main portion and each of an adjacent side auxiliary portions, and an adjacent upper auxiliary portion. When in a deployed condition, hook and loop fasteners are used to enclose openings that are not enclosed by main portion.

However, the related art architectural accessories tend to be fixed, cumbersome, and costly. As such, a long-felt need exists for an apparatus that is lightweight, portable, readily deployable, enhances the visual appearance of an edifice, permeates a gas, provides an optical shield, especially a visual shield, provides a structural shield, and is cost-effective to produce.

### SUMMARY

In addressing many of the problems experienced in the related art architectural accessories, the present disclosure describes an architectural shield apparatus that is lightweight, portable, readily deployable, enhances the visual appearance of an edifice, permeates a gas, provides an optical shield, especially a visual shield, provides a structural shield, and is cost-effective to produce.

In general, the present disclosure encompasses an architectural shield apparatus, comprising: at least one material sheet having an upper portion and a lower portion, the upper portion adapted for rotatable coupling with an edificial feature, and the lower portion adapted for coupling and decoupling with the edificial feature; and at least one deployment device adapted for coupling with the edificial feature and for coupling and decoupling the lower portion of the material sheet in relation to the edificial feature.

Further, the present disclosure encompasses a method of fabricating an architectural shield apparatus, comprising: providing at least one material sheet having an upper portion and a lower portion, the upper portion adapted for rotatable coupling with an edificial feature, and the lower portion adapted for coupling and decoupling with the edificial feature; and providing at least one deployment device adapted for coupling with the edificial feature and for coupling and decoupling the lower portion of the material sheet in relation to the edificial feature.

Furthermore, the present disclosure encompasses a method of using an architectural shield apparatus, the method comprising providing an architectural shield, the architectural shield providing comprises providing a material sheet, providing at least one coupling feature capable of coupling the material sheet with an edificial feature, and providing at least one deployment feature capable of coupling with the material sheet and with an edificial feature, activating the deployment feature, thereby releasing the material sheet for operation.

Benefits of the architectural shield and methods, in accordance with the present disclosure, include, but are not limited to, quick and ready deployability, visual edifice appearance enhancement, gas permeability, visual shielding, structural shielding, and easy fabrication.

These and other objectives and advantages of the invention will become apparent from the following description taken in conjunction with the accompanying drawings wherein and set forth, by way of illustration and example, certain embodiments of the invention. The drawings are intended to constitute a part of this specification and include exemplary embodiments of the present invention and illustrate various objects and features thereof.

### BRIEF DESCRIPTION OF THE DRAWING

The above, and other, aspects, features, and advantages of several embodiments of the present disclosure will be more apparent from the following Detailed Description as presented in conjunction with the following several figures of the Drawing.

FIG. 1 is a diagram illustrating a perspective view of an architectural shield apparatus, comprising a material sheet, as coupled with an edificial feature, such as a garage door, whereby a “screened” room is effected, in accordance with an embodiment of the present disclosure.

FIG. 2A is a diagram illustrating a perspective view of an architectural shield apparatus, comprising a pair of material sheets, as coupled with an edificial feature, such as a garage door, whereby an “screened” anteroom and a “screened” aft room are effected, in accordance with an embodiment of the present disclosure.

FIG. 2B is a diagram illustrating a perspective view of an architectural shield apparatus, comprising a plurality of material sheets, as coupled with an edificial feature, such as a garage door, whereby at least one “screened” anteroom and a “screened” aft room are effected, in accordance with an embodiment of the present disclosure.

FIG. 3A is a diagram illustrating an upward perspective view of an architectural shield apparatus, comprising a plurality of material sheets, as coupled with an edificial feature, such as a cabana, a patio cover, a breezeway, an atrium, a gazebo, a folly, a greenhouse, and a conservatory, whereby a “screened” room is effected, in accordance with an embodiment of the present disclosure.

FIG. 3B is a diagram illustrating a downward perspective view of an architectural shield apparatus, comprising a plurality of material sheets, as coupled with an edificial feature, such as a cabana, a patio cover, a breezeway, an atrium, a gazebo, a folly, a greenhouse, and a conservatory, whereby a “screened” room is effected, in accordance with an embodiment of the present disclosure.

FIG. 4A is a diagram illustrating a front view of a deployment device of an architectural shield apparatus, as coupled with a material sheet and an edificial feature, such as shown in FIGS. 1-3, in accordance with an embodiment of the present disclosure.

FIG. 4B is a diagram illustrating a detailed view of a deployment device of an architectural shield apparatus, as coupled with a material sheet and an edificial feature, such as shown in FIGS. 1-3 and 4A, in accordance with an embodiment of the present disclosure.

FIG. 4C is a diagram illustrating an detailed view of a deployment device of an architectural shield apparatus, as capable of coupling with a material sheet and an edificial feature, such as shown in FIGS. 1-3, in accordance with an alternative embodiment of the present disclosure.

FIG. 5 is a flowchart illustrating a method of fabricating an architectural shield apparatus, comprising providing at least one material sheet adapted for coupling with an edificial feature, such as shown in FIGS. 1-4, whereby a “screened” room is effected, in accordance with an embodiment of the present disclosure.

FIG. 6 is a flowchart illustrating a method of using an architectural shield apparatus, comprising providing at least one material sheet, and providing at least one deployment device, rotatably coupling the at least one material sheet with the edificial feature, and deploying the at least one material sheet in relation to the edificial feature, whereby a screened room is effected, such as shown in FIGS. 1-4, in accordance with an embodiment of the present disclosure.

FIG. 7 is a diagram illustrating a perspective view of an architectural shield apparatus, comprising a material sheet, as shown in FIG. 1, further comprising at least one of at least one peripheral flap and at least one ingress/egress feature, as coupled with an edificial feature, such as shown in FIGS. 1-4, whereby a “screened” room with peripheral shielding is effected, in accordance with an embodiment of the present disclosure.

FIG. 8 is a diagram illustrating a planform view of an architectural shield apparatus, comprising a material sheet, further comprising at least one of at least one peripheral flap, at least one interface feature, at least one frangible feature, and at least one ingress/egress feature, as coupled with an edificial feature, such as a garage door, wherein the material sheet comprises an eco-friendly material, and whereby a “screened” room, such as a temporary, portable, eco-friendly spray booth, is effected, in accordance with an embodiment of the present disclosure.

FIG. 9 is a diagram illustrating a perspective view of an architectural shield apparatus, comprising a material sheet mounted on a lightweight flexible frame and a deployment device comprising at least one clip coupling, as coupled with an edificial feature, such as a garage door, wherein the material sheet comprises at least one opening for facilitating manual grasping of the apparatus by a user for manual decoupling, deployment, and recoupling, whereby a “screened” room is effected, in accordance with an embodiment of the present disclosure.

Corresponding reference characters indicate corresponding components throughout the several figures of the Drawing. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiment are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary embodiments. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

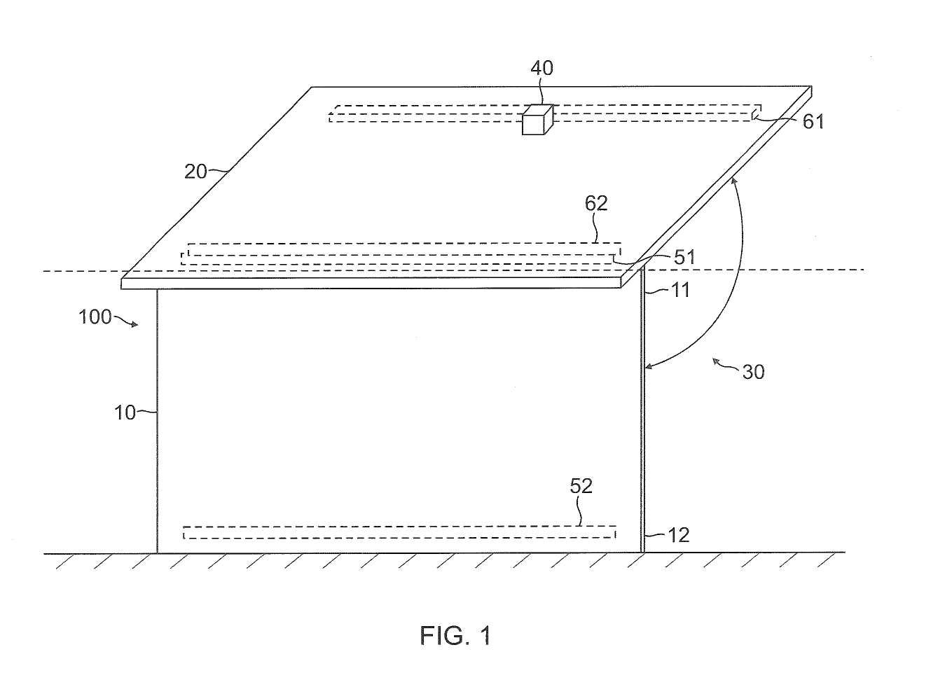

Referring to FIG. 1, this diagram illustrates a perspective view of an architectural shield apparatus 100, comprising a single material sheet 10, as coupled with an edificial feature 20, such as a garage door, by example only, whereby a effective “room” 30, e.g., a “screened” room, is effected, in accordance with an embodiment of the present disclosure. The effective room 30 has the benefit of being both indoor and outdoor at the same time. The effective room 30 provides a popular “man-cave” space for users who have homes without basements. The architectural shield apparatus 100 generally comprises: at least one material sheet 10 having an upper portion 11 and a lower portion 12, the upper portion 11 adapted for rotatable coupling with an edificial feature 20, such as a garage door, for example, and the lower portion 12 adapted for coupling and decoupling with the edificial feature 20; and at least one deployment device 40 adapted for coupling with the edificial feature 20 and for coupling and decoupling the lower portion 12 of the material sheet 10 in relation to the edificial feature 20. Also, the material sheet 10 comprises a size approximating that of the edificial feature 20, e.g., an externally visible portion of the edificial feature 20, for providing optimal coverage.

Still referring to FIG. 1, in the general embodiment, the material sheet 10 comprises at least one upper coupling structure 51 disposed along the upper portion 11 and at least one lower coupling structure 52 disposed along the lower portion 12, the at least one upper coupling structure 51 of the material sheet 10 engageable with at least one corresponding lower coupling structure 62 of the edificial feature 20, and the at least one lower coupling structure 52 of the material sheet 10 engageable with at least one corresponding upper coupling structure 61 of the edificial feature 20. The at least one material sheet 10 comprises at least one of an optional flexible frame, an optional weight, and an optional anchor. The at least one upper coupling structure 51 of the material sheet 10 comprises at least one of a tab loop, a grommet, a casing, a snap, a sliding feature, such as a plurality of ball bearings or any other slidable structure capable of coupling with a track structure, a magnetic feature, a hook-and-loop fastener, a rod, a pin, a hinge structure, and the like. The at least one coupling structure, e.g., the at least one lower coupling structure 62 of the edificial feature 20, comprises at least one of a rod, a bracket, a complementary snap, a complementary sliding feature, such as a track capable of coupling with a sliding feature, e.g., a plurality of ball bearings or any other slidable structure capable of coupling with a track structure, a complementary magnetic feature, a complementary hook-and-loop fastener, a rod receiving feature, a pin receiving feature, a complementary hinge structure, and the like.

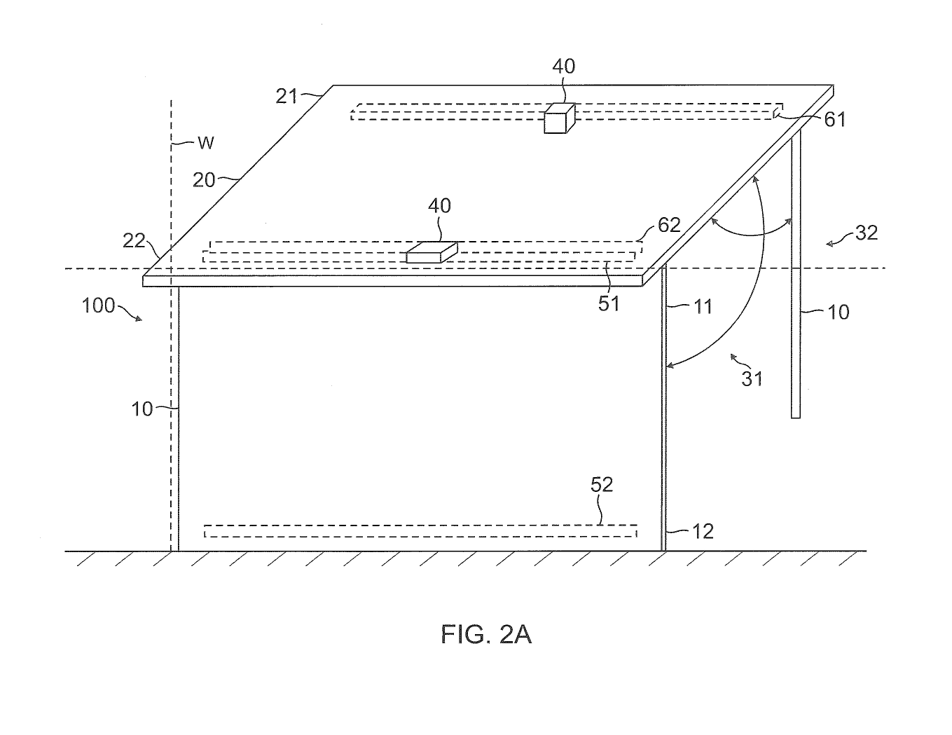

Referring to FIG. 2A, this diagram illustrates a perspective view of an architectural shield apparatus 100, comprising a pair of material sheets 10, as coupled with an edificial feature 20, such as a garage door, whereby an “anteroom” 31 and an “aft” room 32 are effected, in accordance with an embodiment of the present disclosure. The effective anteroom 31 has the benefit of being both indoor and outdoor at the same time while also providing “behind the scenes” privacy in the rear portion of the garage, e.g., an effective “backstage” area or “aft room” 32 formed by the second material sheet 10 and the garage walls W. The anteroom 31, formed by the first material sheet 10 and two of the opposing the garage walls W may be used for conducting business or receiving visitors while providing visual or other shielding for business or other private operations or activities being conducted in the aft room 32.

Still referring to FIG. 2A, the architectural shield apparatus 100 of this embodiment generally comprises: a pair of material sheets 10, each sheet 10 of the pair of sheets 10 having an upper portion 11 and a lower portion 12, the upper portion 11 adapted for rotatable coupling with an edificial feature 20, such as a garage door, for example, and the lower portion 12 adapted for coupling and decoupling with the edificial feature 20; and a plurality of deployment devices 40 adapted for coupling with the edificial feature 20 and for coupling and decoupling the lower portion 12 of each material sheet 10 of the pair of sheets 10 in relation to the edificial feature 20, wherein the upper portion 11 of one of the pair of material sheets 10 is capable of rotatably coupling with an upper portion 21 of the edificial feature 20, e.g., the garage door, and wherein an upper portion 11 of the other of the pair of material sheets 10 is capable of rotatably coupling with a lower portion 22 of the 21 of the edificial feature 20, e.g., the garage door, whereby consecutive deployment of the pair of material sheets 10 effects a screened anteroom 31 as well as a screened aft room 32 in the edificial feature 20.

Referring to FIG. 2B, this diagram illustrates a perspective view of an architectural shield apparatus 100, comprising a plurality of material sheets 10, as coupled with an edificial feature 20, such as a garage door, whereby at least one “anteroom” 31 and an “aft” room 32 are effected, in accordance with an embodiment of the present disclosure. The effective at least one anteroom 31 has the benefit of being both indoor and outdoor at the same time while also providing “behind the scenes” privacy in the rear portion of the garage, e.g., an effective “backstage” area or “aft room” 32 formed by the second material sheet 10 and the garage walls W. The at least one anteroom 31, formed by the first material sheet 10 and at least one other material sheet 10 and/or a garage wall W may be used for conducting business or receiving visitors while providing visual or other shielding for business or other private operations or activities being conducted in the aft room 32.

Still referring to FIG. 2B, the architectural shield apparatus 100 of this embodiment generally comprises: a plurality of material sheets 10, each sheet 10 of the plurality of sheets 10 having an upper portion 11 and a lower portion 12, the upper portion 11 adapted for rotatable coupling with an edificial feature 20, such as a garage door, for example, and the lower portion 12 adapted for coupling and decoupling with the edificial feature 20; and a plurality of deployment devices 40 adapted for coupling with the edificial feature 20 and for coupling and decoupling the lower portion 12 of each material sheet 10 of the plurality of sheets 10 in relation to the edificial feature 20, wherein the upper portion 11 of the first sheet 10 of the plurality of material sheets 10 is capable of rotatably coupling with an upper portion 21 of the edificial feature 20, wherein an upper portion 11 of the second sheet 10 of the plurality of material sheets 10 is capable of rotatably coupling with a lower portion 22 of the 21 of the edificial feature 20, and wherein either an upper portion or a lower portion of any other sheet 10 is capable of rotatably coupling with any other portion of the edificial feature 20, whereby consecutive deployment of the plurality of material sheets 10 effects at least one screened anteroom 31 as well as a screened aft room 32 in relation to the edificial feature 20.

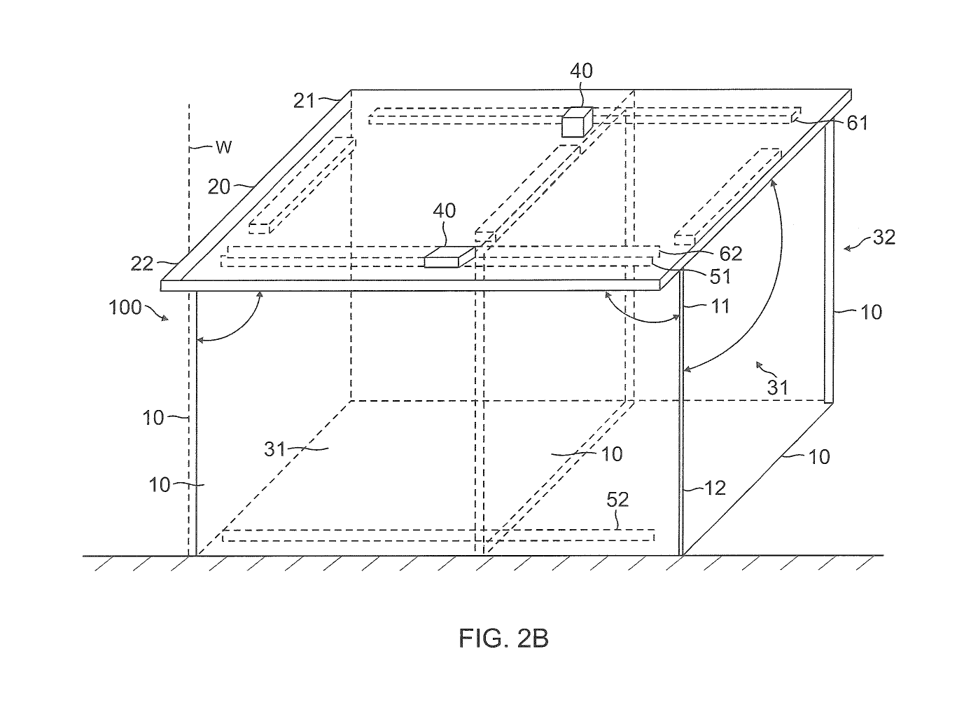

Referring to FIG. 3A, this diagram illustrates an upward perspective view of an architectural shield apparatus 100, comprising a plurality of material sheets 10, as coupled with an edificial feature 20, such as a cabana, a patio cover, a breezeway, an atrium, a gazebo, a folly, a greenhouse, and a conservatory, whereby a “screened” room 30 is effected, in accordance with an embodiment of the present disclosure. In FIG. 3, the apparatus 100, comprising a plurality of material sheets 10, is shown as deployed in relation to a gazebo, by example only. The architectural shield apparatus 100 of this embodiment generally comprises: a plurality of material sheets 10, each sheet 10 of the plurality of sheets 10 having an upper portion 11 and a lower portion 12, the upper portion 11 adapted for rotatable coupling with an edificial feature 20, such as the gazebo frame, for example, and the lower portion 12 adapted for coupling and decoupling with the edificial feature 20; and a plurality of corresponding deployment devices 40 adapted for coupling with the edificial feature 20 and for coupling and decoupling the lower portion 12 of each material sheet 10 of the plurality of sheets 10 in relation to the edificial feature 20, wherein the upper portion 11 of each of the plurality of material sheets 10 is capable of rotatably coupling with an upper portion 21 of the edificial feature 20, e.g., the gazebo frame, whereby deployment of the plurality of material sheets 10 effects a screened room 30 in the edificial feature 20.

Referring to FIG. 3B, this diagram illustrates a downward perspective view of an architectural shield apparatus 100, comprising a plurality of material sheets 10, as coupled with an edificial feature 20, such as a cabana, a patio cover, a breezeway, an atrium, a gazebo, a folly, a greenhouse, and a conservatory, whereby a “screened” room 30 is effected, in accordance with an embodiment of the present disclosure. In FIG. 3, the apparatus 100, comprising a plurality of material sheets 10, is shown as deployed in relation to a gazebo, by example only. The architectural shield apparatus 100 of this embodiment generally comprises: a plurality of material sheets 10, each sheet 10 of the plurality of sheets 10 having an upper portion 11 and a lower portion 12, the upper portion 11 adapted for rotatable coupling with an edificial feature 20, such as the gazebo frame, for example, and the lower portion 12 adapted for coupling and decoupling with the edificial feature 20; and a plurality of corresponding deployment devices 40 adapted for coupling with the edificial feature 20 and for coupling and decoupling the lower portion 12 of each material sheet 10 of the plurality of sheets 10 in relation to the edificial feature 20, wherein the upper portion 11 of each of the plurality of material sheets 10 is capable of rotatably coupling with an upper portion 21 of the edificial feature 20, e.g., the gazebo frame, whereby deployment of the plurality of material sheets 10 effects a screened room 30 in the edificial feature 20.

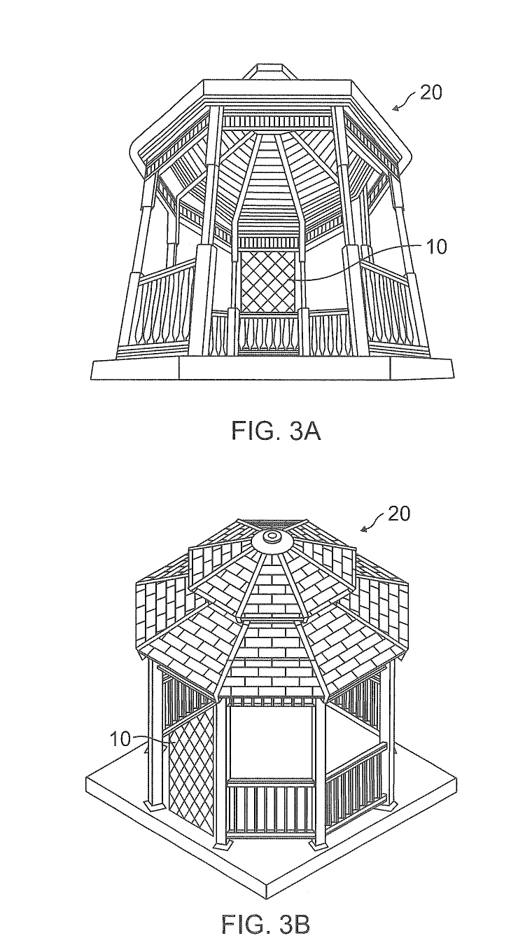

Referring to FIG. 4A, this diagram illustrates a front view of a deployment device 40 of an architectural shield apparatus 100, as coupled with a material sheet 10 and an edificial feature 20, such as a garage door, as shown in FIGS. 1-3, in accordance with an embodiment of the present disclosure. The deployment device 40 comprises not only a spring-loaded latching mechanism or a spring-loaded rotation and translation mechanism, as shown in FIG. 4A, by example only, but comprises any other mechanical, electrical, or electromechanical device for quick connect, quick disconnect, and quick deployment of the material sheet 10. The deployment device 40 is further capable of decoupling and recoupling the material sheet 10 with the edificial feature 20, such as by a chain, wire, and cable. The deployment device 40 is operable by at least one of a mechanical actuator, an electric actuator, an electromechanical actuator, and a magnetic actuator.

Referring to FIGS. 4B and 4C, these diagrams respectively illustrate detailed views of a deployment device 40 of an architectural shield apparatus 100, as coupled with a material sheet 10 and an edificial feature 20, such as shown in FIGS. 1-3 and 4A, in accordance with alternative embodiments of the present disclosure. The deployment device 40 comprises at least one rotatable member 41, such as a handle (e.g., as in FIG. 4C), a knob (e.g., as in FIG. 4B), a cam, a wheel, and a disc, at least one horizontal member 42, such as a lightweight shaft, having a proximal end 42a and a distal end 42b, the at least one horizontal member proximal end 42a capable of pivotally coupling with the rotatable member 41, and the at least one horizontal member distal end 42b capable of translatingly coupling with the at least one coupling structure of the edificial feature 20, such as the at least one upper coupling structure 61 and the at least one lower coupling structure 62 of the edificial feature 20. The at least one coupling structure of the edificial feature 20 comprises a bracket 63 mounted to the edificial structure 20, the bracket having at least one receiving structure, such as an orifice, a tap hole, a depression, and a detent for accommodating the horizontal member distal end 42b when the sheet 10 is undeployed. The horizontal member proximal end 42a is capable of coupling with the rotatable member 41 at a tangential location as shown in FIG. 4, whereby rotation of the rotatable member 41 urges the horizontal member distal end 42b away from the bracket 63 and toward the rotatable member 41, and whereby the sheet 10 is deployable. The rotatable member 41 further comprises at least one spring 43 for redisposing the at least one horizontal member 42 in its original position. The horizontal member distal end 42b comprises a diagonal cross-section for facilitating recoupling the sheet 10 with the edificial feature 20 when the at least one spring 43 is released.

Still referring to FIGS. 4A-4C, the deployment device 40, in any embodiment, alternatively comprises at least one magnet actuator 44, such as a manual magnet actuator, an electronic magnet actuator, and a electromechanically magnet actuator, and at least one reversible polarity magnet 45 coupled with the at least one magnet actuator 44. The at least one reversible polarity magnet 45 capable of coupling and decoupling with a complementary magnet associated with the sheet 10. For any of the embodiments of the deployment device 40 of the present disclosure, actuation may be initiated via any of manual initiation, electronic initiation, electromechanical initiation, wireless communication, wire line communication, sound activation, e.g., clapping, and voice activation.

Referring to back to FIGS. 1-3, the apparatus 100 is adaptable to a variety of edificial features 20. For instance, the edificial feature 20 comprises at least one of a garage door, a loading dock port, a cabana, a carport, a patio cover, a breezeway, an atrium, a gazebo, a folly, a greenhouse, a conservatory, and any other externally visible architectural structure. In addition, the material sheet 10 comprises at least one of a visual enhancement feature, a gas permeability feature, a selective gas permeability feature, a liquid impermeability feature, a liquid repellant feature, an antimicrobial feature, an ionic breeze feature, an optical shielding feature, a selective optical shielding feature, and a structural shielding feature.

Still referring back to FIGS. 1-3, the visual enhancement feature comprises at least one of a printed image, a silkscreen image, a lithograph image, a manually applied image, an integral image, a woven image, a needlework image, an appliqué image, an image comprising at least one of an advertisement, a trademark, and a logo, a digital display, and a video display. The visual enhancement feature also comprises an actual size image of the garage door's exterior surface itself in order to give the appearance of the garage door being in a closed disposition while the garage door is actually in an open disposition. The video display further comprises at least one of a USB connector and a USB cable for facilitating electronic communication with video equipment. The gas permeability feature comprises at least one of a tarp material, a porous material, a mesh material, and a screen material.

Still referring back to FIGS. 1-3, the optical shielding feature comprises at least one of a camouflage feature, a camouflaging image, a one-way visibility feature, and an antireflective feature. The antireflective feature comprises a material having an antireflective property in at least one spectrum of a visible wavelength range, an infrared wavelength range, a near-infrared wavelength range, an ultraviolet wavelength range, and a near ultraviolet wavelength range.

Still referring back to FIGS. 1-3, the structural shielding feature comprises at least one of an antiballistic feature, an anti-blade feature, a tear-resistant feature, and a flame retardant feature. The antiballistic feature and the anti-blade feature each comprise at least one material of a Kevlar®, a high density polyethylene (HDPE), such as Delrin®, an ultra-high molecular weight polyethylene fiber, a vulcanized rubber, an aluminum material, and aluminum alloy material, a polyvinyl chloride (PVC) material, a polycarbonate, such as Lexan® and Makrolon®, an acrylonitrile-butadiene-styrene (ABS) plastic, such as a monolayer and a co-extruded multilayer ABS, an ABS/PVC alloy, such as Royalite®R59, a high-impact fire-rated aircraft-approved material, such as a Kydex®100 material, a high-impact Polystyrene (HIPS), a conductive HIPS, an acrylic material, such as polymethyl methacrylate (PMMA), a polyethylene terephthalate (PETG), such as PETG/Spectar® co-polyester material, and the like. The flame retardant feature comprises at least one material, such as a flame retardant ABS plastic, a polytetrafluoroethylene (PTFE), a fluorinated ethylene propylene (FEP), a perfluoroalkoxy (PFA), a polyimide material, such as a Kapton® and Kaptrex®, a polyamide material, a polyether ether ketone (PEEK), and a polyetherimide (PEI), a polyvinylidene fluoride (PVF), a polyvinylidene difluoride (PVDF), such as Kynar®, and the like.

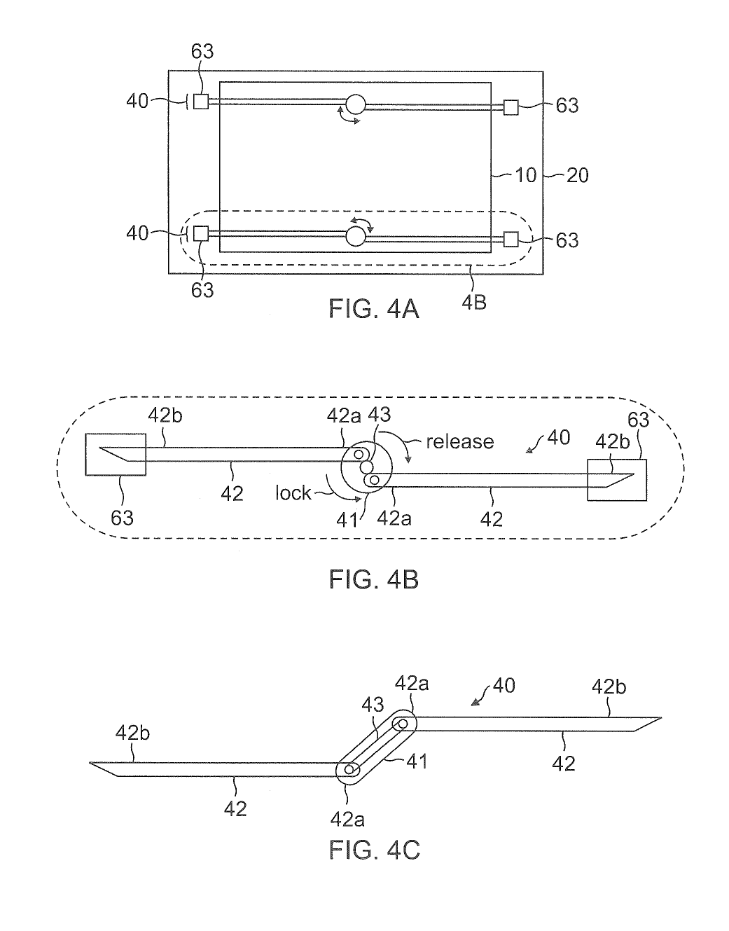

Referring to FIG. 5, this flowchart illustrates a method M₁ of fabricating an architectural shield apparatus 100, comprising providing at least one material sheet 10 adapted for coupling with an edificial feature 20, such as a garage door, whereby a “screened” room 30 is effected, in accordance with an embodiment of the present disclosure. The method M₁ of fabricating an architectural shield apparatus 100 comprises: providing at least one material sheet 10 having an upper portion 11 and a lower portion 12, the upper portion 11 adapted for rotatable coupling with an edificial feature 20, and the lower portion 12 adapted for coupling and decoupling with the edificial feature 20, as indicated by block 1001; and providing at least one deployment device 40 adapted for coupling with the edificial feature 20 and for coupling and decoupling the lower portion 12 of the material sheet 10 in relation to the edificial feature 20, as indicated by block 1002.

Still referring to FIG. 5, in the method M₁, the material sheet 10 providing comprises providing the at least one material sheet 10 in a size approximating that of the edificial feature 20 for providing coverage. The material sheet 10 providing, as indicated by block 1001, comprises providing the at least one material sheet 10 with at least one upper coupling structure 13 disposed along the upper portion 11 and at least one optional lower coupling structure 14 disposed along the lower portion 12, the at least one upper coupling structure 13 of the material sheet 10 engageable with at least one corresponding upper coupling structure 23 of the edificial feature 20, and the at least one optional lower coupling structure 14 of the material sheet 10 engageable with at least one corresponding optional lower coupling structure 24 of the edificial feature 20. Optionally, the at least one material sheet 10 comprises at least one of an optional flexible frame, an optional weight, and an optional anchor. The at least one upper coupling structure 13 providing comprises providing the at least one material sheet 10 with at least one of a tab loop, a grommet, a casing, a snap, a sliding feature, a magnetic feature, a hook-and-loop fastener, a rod, a pin, a hinge structure, and the like. The at least one optional lower coupling structure 14 of the edificial feature 20, comprises at least one of a rod, a bracket, a complementary snap, a complementary sliding feature, a complementary magnetic feature, a complementary hook-and-loop fastener, a rod receiving feature, a pin receiving feature, a complementary hinge structure, and the like.

Still referring to FIG. 5, in the method M₁, the at least one material sheet 10 providing, as indicated by block 1001, comprises providing the at least one material sheet 10 with at least one of at least one of a visual enhancement feature 15, a gas permeability feature, a selective gas permeability feature, a liquid impermeability feature, a liquid repellant feature, an antimicrobial feature, an ionic breeze feature, an optical shielding feature, a selective optical shielding feature, and a structural shielding feature.

Still referring to FIG. 5, in the method M₁, the at least one material sheet 10 providing, as indicated by block 1001, comprises providing the at least one material sheet 10 with a visual enhancement feature 15, e.g., at least one of a printed image, a silkscreen image, a lithograph image, a manually applied image, an integral image, a woven image, a needlework image, an appliqué image, an image comprising at least one of an advertisement, a trademark, and a logo, a digital display, and a video display, such as a gas permeability feature, e.g., a tarp material, a porous material, a mesh material, and a screen material.

Still referring to FIG. 5, in the method M₁, the at least one material sheet 10 providing, as indicated by block 1001, comprises providing the at least one material sheet 10 with an optical shielding feature, e.g., a camouflage feature, a camouflaging image, a one-way visibility feature, and an antireflective feature, such as an antireflective feature, e.g., a material having an antireflective property in at least one spectrum of a visible wavelength range, an infrared wavelength range, a near-infrared wavelength range, an ultraviolet wavelength range, and a near ultraviolet wavelength range.

Still referring to FIG. 5, in the method M₁, the at least one material sheet 10 providing, as indicated by block 1001, comprises providing the at least one material sheet 10 with a structural shielding feature, e.g., an antiballistic feature, an anti-blade feature, a tear-resistant feature, and a flame retardant feature. The antiballistic feature and the anti-blade feature each comprise at least one material of a Kevlar®, a high density polyethylene (HDPE), such as Delrin®, an ultra-high molecular weight polyethylene fiber, a vulcanized rubber, an aluminum material, and aluminum alloy material, a polyvinyl chloride (PVC) material, a polycarbonate, such as Lexan® and Makrolon®, an acrylonitrile-butadiene-styrene (ABS) plastic, such as a monolayer and a co-extruded multilayer ABS, an ABS/PVC alloy, such as Royalite®R59, a high-impact fire-rated aircraft-approved material, such as a Kydex® 100 material, a high-impact Polystyrene (HIPS), a conductive HIPS, an acrylic material, such as polymethyl methacrylate (PMMA), a polyethylene terephthalate (PETG), such as PETG/Spectar® co-polyester material, and the like. The flame retardant feature comprises at least one material, such as a flame retardant ABS plastic, a polytetrafluoroethylene (PTFE), a fluorinated ethylene propylene (FEP), a perfluoroalkoxy (PFA), a polyimide material, such as a Kapton® and Kaptrex®, a polyamide material, a polyether ether ketone (PEEK), and a polyetherimide (PEI), a polyvinylidene fluoride (PVF), a polyvinylidene difluoride (PVDF), such as Kynar®, and the like.

Still referring to FIG. 5, in the method M₁, the deployment device 40 providing, as indicated by block 1002, comprises providing the deployment device 40 as further capable of decoupling and recoupling the at least one material sheet 10 with the edificial feature 20. Also, the deployment device 40 providing comprises providing the deployment device 40 as operable by at least one of a mechanical actuator, an electric actuator, an electromechanical actuator, and a magnetic actuator.

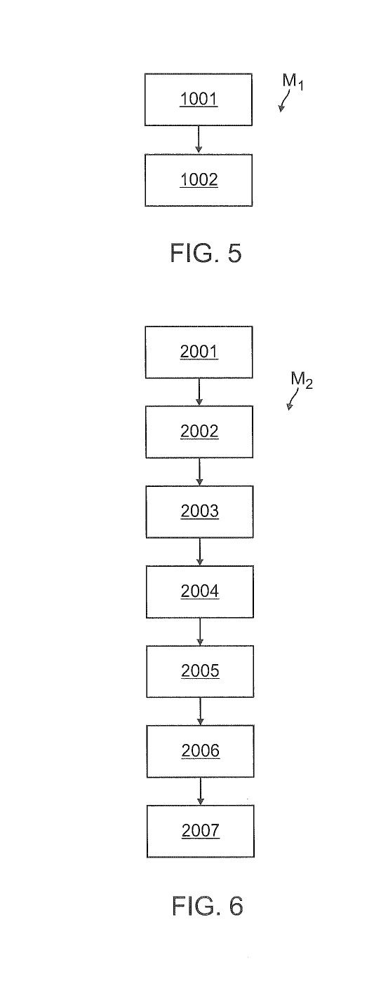

Referring to FIG. 6, this flowchart illustrates a method M₂ of using an architectural shield apparatus 100, comprising: providing at least one material sheet 10 having an upper portion 11 and a lower portion 12, the upper portion 11 adapted for rotatable coupling with an edificial feature 20, and the lower portion 12 adapted for coupling and decoupling with the edificial feature 20, as indicated by block 2001; providing at least one deployment device 40 adapted for coupling with the edificial feature 20 and for coupling and decoupling the lower portion 12 of the material sheet 10 in relation to the edificial feature 20, as indicated by block 2002; rotatably coupling the at least one material sheet 10 with the edificial feature 20, as indicated by block 2003; and deploying the at least one material sheet 10 in relation to the edificial feature 20, whereby a screened room 30 is effected, as indicated by block 2004, in accordance with an embodiment of the present disclosure.

Still Referring to FIG. 6, the method M₂ further comprises recoupling the lower portion of the at least one material sheet in relation to the edificial feature, as indicated by block 2005. In performing the method M₂, the apparatus 100 may be used with an edificial feature 20 comprising at least one of a garage door, a carport, a loading dock port, a cabana, a patio cover, a portico, a breezeway, an atrium, a gazebo, a folly, a greenhouse, a conservatory, and any other externally visible architectural structure. For example, the method M₂ may be practiced, wherein the at least one material sheet 10 providing comprises providing a pair of material sheets 10, and further comprising: rotatably coupling an upper portion 11 of one of the pair of material sheets 10 with an upper portion 21 of an edificial feature 20, e.g., a garage door, as indicated by block 2006, and rotatably coupling an upper portion 11 of the other of the pair of material sheets 10 with a lower portion 22 of the edificial feature 20, e.g., the garage door, as indicated by block 2007, whereby consecutive deployment of the pair of material sheets 10 effects a screened anteroom 31 in a garage 33.

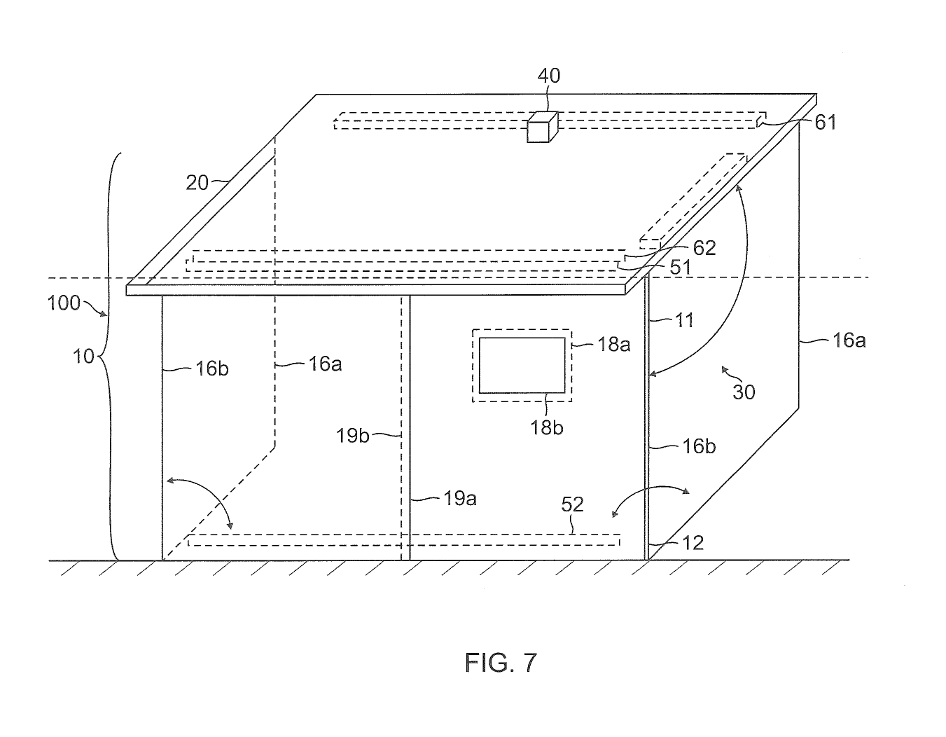

Referring to FIG. 7, this diagram illustrates a perspective view of an architectural shield apparatus 100, comprising at least one material sheet 10, as shown in FIG. 1, further comprising at least one of at least one peripheral flap 16a and at least one ingress/egress feature 17, as coupled with an edificial feature 20, such as shown in FIGS. 1-4, whereby a “screened” room 30, whereby with peripheral shielding is effected, in accordance with an embodiment of the present disclosure. The at least one peripheral flap 16a is coupled with the at least one material sheet 10 by way of at least one interface feature 16b, such as a fold, a seam, a weld, and a seam-weld, and any other suitable interface structure. The apparatus 100 of this embodiment may also be coupled with, and deployed from, an edificial feature 20 by way the deployment device 40, as shown in FIG. 4.

Still referring to FIG. 7, the at least one ingress/egress feature, by example only, comprises at least one of a flap 18a in closable relation with a window opening 18b in the at least one material sheet 10, a slit 19a forming a door opening in the at least one material sheet 10, and overlapping portions 19b of the at least one material sheet 10. The window opening 18b optionally comprises a material having a larger porosity, e.g., a larger mesh, than that of the material sheet 10 for facilitating ventilation in the room 30. The apparatus 100 further comprises at least one fastener, such as a magnetic coupling, a hook-and-loop coupling, e.g., Velcro®, a snap coupling, and a hook-and-eye coupling, for facilitating closing and opening of the flap 18a in relation to the window opening 18b and the overlapping portions 19b in relation to one another.

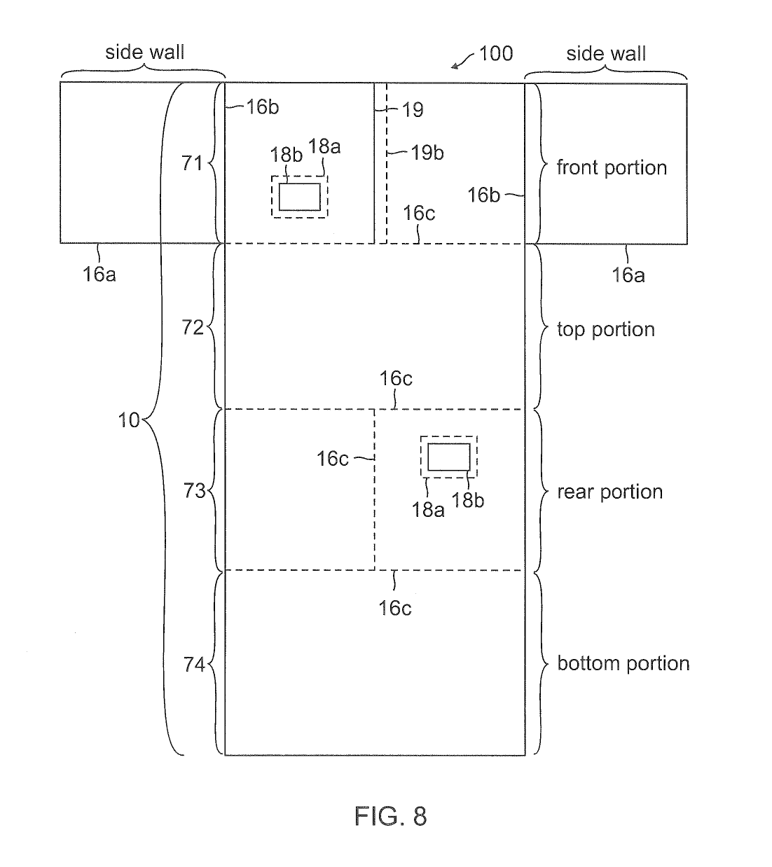

Referring to FIG. 8, this diagram illustrates a planform view of an architectural shield apparatus 100, comprising a material sheet 10, further comprising at least one of at least one peripheral flap 16a, at least one interface feature 16b, such as a fold, a seam, a weld, and a seam-weld, at least one frangible feature 16c, and at least one ingress/egress feature, as coupled with an edificial feature 20, such as a garage door, wherein the material sheet 10 comprises an eco-friendly material, such as a recycled material, a recyclable material, a biodegradable material, a disposable material, such as a paper and a cardboard, whereby a “screened” room 30, such as a portable, disposable, eco-friendly spray booth, is effected, in accordance with an embodiment of the present disclosure.

Still referring to FIG. 8, the at least one peripheral flap 16a, forming at least one side wall, is coupled with the at least one material sheet 10 by way of at least one interface feature 16b, such as a fold, a seam, a weld, a seam-weld, and any other suitable interface structure. The material sheet 10 comprises a front portion 71 contiguous with the at least one peripheral flap 16a, a top portion 72 contiguous with the front portion 71, a rear portion 73 contiguous with the top portion 72, and a bottom portion 74 contiguous with the rear portion 73, wherein deployment of the apparatus 100 provides a temporary spray booth which prevents spray or overspray of other objects in a structure, such as a garage. The at least one frangible portion 16c facilitates deployment of the apparatus 100 into a desired configuration, e.g., the spray booth configuration, optionally having at least one ingress/egress. The at least one flap 16a forms at least one sidewall. The apparatus 100 of this embodiment may also be coupled with, and deployed from, an edificial feature 20 by way the deployment device 40, as shown in FIG. 4, or alternatively, by way of a plurality of temporary fasteners, such as hook-and-loop fasteners, having an adhesive backing, double-stick tape, and the like. The apparatus 100 of this embodiment comprises a size corresponding to that of a garage door, such as a one-car garage door and a two-car garage door, by example only, while custom and oversized garage doors are contemplated and encompassed by the present disclosure.

Still referring to FIG. 8, the at least one ingress/egress feature comprises at least one of a flap 18a in closable relation with a window opening 18b in the at least one material sheet 10, a slit 19a forming a door opening in the at least one material sheet 10 by tearing the at least one frangible portion 16c, and overlapping portions 19b of the at least one material sheet 10. The window opening 18b optionally comprises a material having a larger porosity, e.g., a larger mesh, than that of the material sheet 10 for facilitating ventilation in the room 30, e.g., the temporary spray booth. The apparatus 100 further comprises at least one fastener comprising a disposable eco-friendly material, such as a disposable eco-friendly hook-and-loop coupling, e.g., a disposable eco-friendly Velcro®, a disposable eco-friendly snap coupling for facilitating closing and opening of the flap 18a in relation to the window opening 18b and the overlapping portions 19b in relation to one another. The apparatus 100 further comprises: a ventilation device (not shown) that is powered by a power source, such as a power outlet, a battery, and a solar source, for removing undesirable volatiles and other hazardous materials from the spray booth; and a filter (not shown) or a cold trap (not shown) for preventing the escape of such undesirable volatiles and other hazardous materials into the environment.

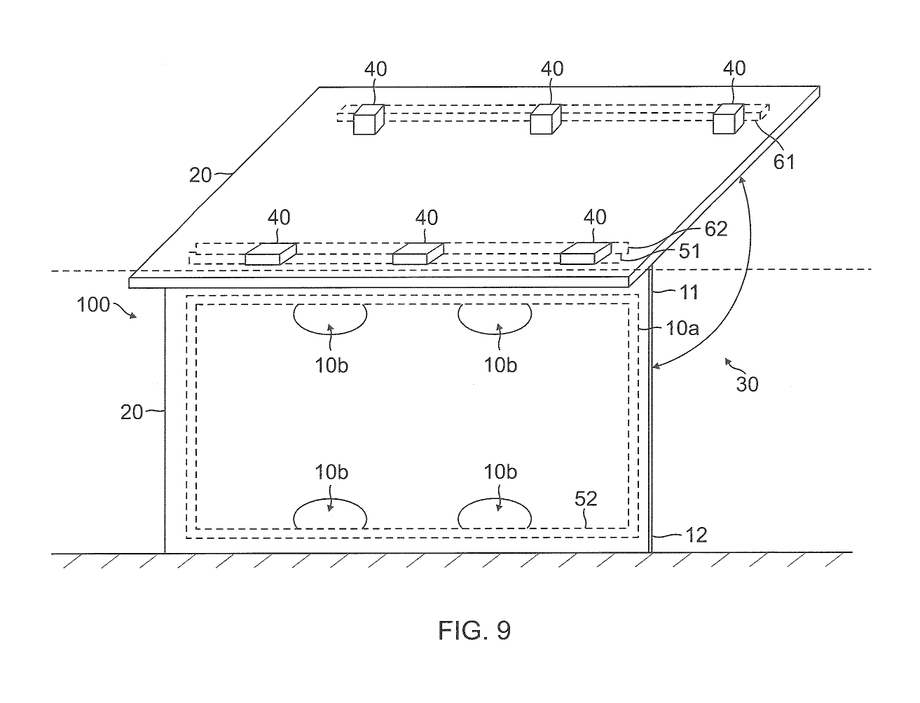

Referring to FIG. 9, this diagram illustrates a perspective view of an architectural shield apparatus 100, comprising a material sheet 10 mounted on a lightweight flexible frame 10a and a deployment device 40 comprising at least one clip coupling, as coupled with an edificial feature 20, such as a garage door, wherein the material sheet 10 comprises at least one opening 10b for facilitating manual grasping of the apparatus 100 by a user (not shown) for manual deployment and manual decoupling and recoupling, whereby a “screened” room 30 is effected, in accordance with an embodiment of the present disclosure. One portion of the clip coupling is disposed in relation to at least one frame member of the garage door while the complementary portion is disposed in a corresponding location in relation to lightweight flexible frame 10a. In this embodiment, an upper portion 11 of the material sheet 10 is rotatably coupled with a lower portion 22 of the edificial feature 20, whereby deployment of the apparatus 100 forms a screened room 30 comprising a volume approximate that of the garage.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed:

1. An architectural shield apparatus, the apparatus comprising:
at least one material sheet having an upper portion and a lower portion, the upper portion adapted for rotatable coupling with an edificial feature, and the lower portion adapted for coupling and decoupling with the edificial feature; and
at least one deployment device adapted for coupling with the edificial feature and for coupling and decoupling the lower portion of the material sheet in relation to the edificial feature.

2. The apparatus of claim 1,
wherein the material sheet comprises a size approximating that of the edificial feature for providing coverage,
wherein the material sheet comprises at least one upper coupling structure disposed along the upper portion and at least one optional lower coupling structure disposed along the lower portion, the at least one upper coupling structure of the material sheet engageable with at least one corresponding upper coupling structure of the edificial feature, and the at least one optional lower coupling structure of the material sheet engageable with at least one corresponding optional lower coupling structure of the edificial feature,
wherein the at least one material sheet comprises at least one of a flexible lightweight frame, a weight, and a anchor, and
wherein the at least one upper coupling structure comprises at least one of a tab loop, a grommet, a casing, a snap, a sliding feature, a magnetic feature, a hook-and-loop fastener, a rod, a pin, a hinge structure.

3. The apparatus of claim 1, wherein the material sheet comprises at least one of a visual enhancement feature, a gas permeability feature, a selective gas permeability feature, a liquid impermeability feature, a liquid repellant feature, an antimicrobial feature, an ionic breeze feature, an optical shielding feature, a selective optical shielding feature, and a structural shielding feature.

4. The apparatus of claim 1, wherein the at least one coupling structure of the edificial feature and comprises at least one of a rod, a bracket, a complementary snap, a complementary sliding feature, a complementary magnetic feature, a complementary hook-and-loop fastener, a rod receiving feature, a pin receiving feature, and a complementary hinge structure.

5. The apparatus of claim 1, wherein the edificial feature comprises at least one of a garage door, a carport, a loading dock port, a cabana, a patio cover, a portico, a breezeway, an atrium, a gazebo, a folly, a greenhouse, a conservatory, and any other externally visible architectural structure.

6. The apparatus of claim 1,
wherein the deployment device is further capable of decoupling and recoupling the material sheet with the edificial feature, and
wherein the deployment device is operable by at least one of a mechanical actuator, an electric actuator, an electromechanical actuator, and a magnetic actuator.

7. The apparatus of claim 3, wherein the visual enhancement feature comprises at least one of a printed image, a silkscreen image, a lithograph image, a manually applied image, an integral image, a woven image, a needlework image, an appliqué image, an image comprising at least one of an advertisement, a trademark, and a logo, a digital display, and a video display.

8. The apparatus of claim 3, wherein the gas permeability feature comprises at least one of a tarp material, a porous material, a mesh material, and a screen material.

9. The apparatus of claim 3, wherein the optical shielding feature comprises at least one of a camouflage feature, a camouflaging image, a one-way visibility feature, and an antireflective feature.

10. The apparatus of claim 9, wherein the antireflective feature comprises a material having an antireflective property in at least one spectrum of a visible wavelength range, an infrared wavelength range, a near-infrared wavelength range, an ultraviolet wavelength range, and a near ultraviolet wavelength range.

11. The apparatus of claim 2, wherein the structural shielding feature comprises at least one of an antiballistic feature, an anti-blade feature, a tear-resistant feature, and a flame retardant feature.

12. The apparatus of claim 11,
wherein the antiballistic feature and the anti-blade feature each comprise at least one material of a Kevlar®, a high density polyethylene (HDPE), a Delrin®, an ultra-high molecular weight polyethylene fiber, a vulcanized rubber, an aluminum material, and aluminum alloy material, a polyvinyl chloride material, a polycarbonate, an acrylonitrile-butadiene-styrene plastic, a monolayer acrylonitrile-butadiene-styrene plastic, a co-extruded multilayer acrylonitrile-butadiene-styrene plastic, an acrylonitrile-butadiene-styrene/polyvinyl chloride alloy, a high-impact fire-rated aircraft-approved material, a high-impact polystyrene, a conductive high-impact polystyrene, an acrylic material, a polymethyl methacrylate, a polyethylene terephthalate, and
wherein the flame retardant feature comprises at least one material of a flame retardant acrylonitrile-butadiene-styrene plastic, a polytetrafluoroethylene, a fluorinated ethylene propylene, a perfluoroalkoxy, a polyimide material, a polyamide material, a polyether ether ketone, a polyetherimide, a polyvinylidene fluoride, and a polyvinylidene difluoride.

13. The apparatus of claim 1, wherein the at least one material sheet effects a screened room.

14. The apparatus of claim 5,
wherein the at least one material sheet comprises a pair of material sheets,
wherein one of the pair of material sheets is rotatably coupled with an upper portion of the garage door,
wherein the other of the pair of material sheets is rotatably coupled with a lower portion of the garage door,
whereby consecutive deployment of the pair of material sheets effects a screened anteroom in a garage.

15. A method of fabricating an architectural shield apparatus, comprising:
providing at least one material sheet having an upper portion and a lower portion, the upper portion adapted for rotatable coupling with an edificial feature, and the lower portion adapted for coupling and decoupling with the edificial feature; and
providing at least one deployment device adapted for coupling with the edificial feature and for coupling and decoupling the lower portion of the material sheet in relation to the edificial feature.

16. The method of claim 15,
wherein the material sheet providing comprises providing the at least one material sheet in a size approximating that of the edificial feature for providing coverage,
wherein the material sheet providing comprises providing the at least one material sheet with at least one upper coupling structure disposed along the upper portion and at least one optional lower coupling structure disposed along the lower portion, the at least one upper coupling structure of the material sheet engageable with at least one corresponding upper coupling structure of the edificial feature, and the at least one optional lower coupling structure of the material sheet engageable with at least one corresponding optional lower coupling structure of the edificial feature,
wherein the at least one material sheet comprises at least one of an optional flexible frame, an optional weight, and an optional anchor, and
wherein the at least one upper coupling structure providing comprises providing the at least one material sheet with at least one of a tab loop, a grommet, a casing, a snap, a sliding feature, a magnetic feature, a hook-and-loop fastener, a rod, a pin, a hinge structure.

17. The method of claim 15, wherein the at least one material sheet providing comprises providing the at least one material sheet with at least one of at least one of a visual enhancement feature, a gas permeability feature, a selective gas permeability feature, a liquid impermeability feature, a liquid repellant feature, an antimicrobial feature, an ionic breeze feature, an optical shielding feature, a selective optical shielding feature, and a structural shielding feature.

18. The method of claim 15,
wherein the deployment device providing comprises providing the deployment device as further capable of decoupling and recoupling the material sheet with the edificial feature, and
wherein the deployment device providing comprises providing the deployment device as operable by at least one of a mechanical actuator, an electric actuator, an electromechanical actuator, and a magnetic actuator.

19. The method of claim 17, wherein the visual enhancement feature comprises at least one of a printed image, a silkscreen image, a lithograph image, a manually applied image, an integral image, a woven image, a needlework image, an appliqué image, an image comprising at least one of an advertisement, a trademark, and a logo, a digital display, and a video display.

20. The method of claim 17, wherein the gas permeability feature providing comprises providing at least one of a tarp material, a porous material, a mesh material, and a screen material.

21. The method of claim 17, wherein the optical shielding feature providing comprises providing at least one of a camouflage feature, a camouflaging image, a one-way visibility feature, and an antireflective feature.

22. The method of claim 21, wherein the antireflective feature providing comprises providing a material having an antireflective property in at least one spectrum of a visible wavelength range, an infrared wavelength range, a near-infrared wavelength range, an ultraviolet wavelength range, and a near ultraviolet wavelength range.

23. The method of claim 16, wherein the structural shielding feature providing comprises providing at least one of an antiballistic feature, an anti-blade feature, a tear-resistant feature, and a flame retardant feature.

24. The method of claim 23, wherein the antiballistic feature providing and the anti-blade feature providing each comprise providing at least one material of a Kevlar®, a high density polyethylene, a Delrin®, an ultra-high molecular weight polyethylene fiber, a vulcanized rubber, an aluminum material, and aluminum alloy material, a polyvinyl chloride material, a polycarbonate, an acrylonitrile-butadiene-styrene plastic, a monolayer acrylonitrile-butadiene-styrene plastic, a co-extruded multilayer acrylonitrile-butadiene-styrene plastic, an acrylonitrile-butadiene-styrene/polyvinyl chloride alloy, a high-impact fire-rated aircraft-approved material, a high-impact polystyrene, a conductive high-impact polystyrene, an acrylic material, a polymethyl methacrylate, a polyethylene terephthalate, and
wherein the flame retardant feature providing comprises providing at least one material of a flame retardant acrylonitrile-butadiene-styrene plastic, a polytetrafluoroethylene, a fluorinated ethylene propylene, a perfluoroalkoxy, a polyimide material, a polyamide material, a polyether ether ketone, a polyetherimide, a polyvinylidene fluoride, and a polyvinylidene difluoride.

25. A method of using an architectural shield apparatus, comprising:
providing at least one material sheet having an upper portion and a lower portion, the upper portion adapted for rotatable coupling with an edificial feature, and the lower portion adapted for coupling and decoupling with the edificial feature;
providing at least one deployment device adapted for coupling with the edificial feature and for coupling and decoupling the lower portion of the material sheet in relation to the edificial feature;
rotatably coupling the at least one material sheet with the edificial feature; and
deploying the at least one material sheet in relation to the edificial feature, whereby a screened room is effected.
